(19) United States
(12) Patent Application Publication
(10) Pub. No.: US 2003/0225872 A1
(43) Pub. Date: Dec. 4, 2003

(54) Consolidated management of remot and local application logs

(75) Inventors: Velda A. Bartek, Apex, NC (US); Deane B. Cheatham, Raleigh, NC (US); Claudia E. Harris, Raleigh, NC (US); Dennis E. Myers, Apex, NC (US); Steven M. Pritko, Apex, NC (US); Xiaohu Sherwood Yao, Apex, NC (US)

Correspondence Address: Gerald R. Woods, IBM Corporation T81/503, PO Box 12195, Research Triangle Park, NC, 27709, US

(73) Assignee: International Business Machines Corporation, Armonk, NY (US)

(21) Appl. No.: 10/157,277

(22) Filed: May 29, 2002

(51) Int. Cl. G06F 15/173; G06F 15/16

(52) U.S. Cl. 709/223; 709/201

(57) ABSTRACT

A system and method for concurrently managing remote and local logs in a consolidated log manager. A consolidated log manager can include concurrently displayable log windows, each log window displaying log text from different logs in a distributed system. The log manager further can include a log loader configured to locate the different logs in the distributed system and to load log text from the located different logs in the log windows. Each log window can include a log text editor configured to edit log text loaded in the log window. Additionally, the different logs can include logs remotely disposed from the consolidated log manager about a computer communications network, as well as logs which are local to the consolidated log manager.

### BACKGROUND OF THE INVENTION

1. Statement of the Technical Field

The present invention relates to an application log viewer, and more particularly to the management of multiple application logs within a single viewer.

2. Description of the Related Art

During the execution of software applications, a wide variety of information can be written to corresponding application logs. Administrators can view each application log for a number of purposes including troubleshooting application execution problems, conducting performance evaluations, and managing system and network operations. Typically, each application log can be viewed in a window which is separate both from the application and other application logs. In that regard, it is a well-known standard practice to launch separate display windows for each application log through which the application information can be displayed. Frequently, the display windows can be text editors in which the application logs can be edited using standard editing functions, such as cut, copy and paste.

While troubleshooting or checking system operations, it can be helpful for application administrators to view multiple display logs simultaneously, each display log corresponding to differing applications. For instance, examining system performance or troubleshooting application problems typically can require the concurrent comparing of application execution information across multiple application logs. Specifically, an application administrator might view all of the application logs for a system having several applications installed. Moreover, the administrator might view all of the application logs, side by side to determine events that were occurring at a particular time across the installed applications. To accomplish concurrent viewing, however, application administrators first must open multiple windows in multiple log viewers for each application to view all of the logs associated with the applications.

Importantly, in a distributed environment, to view remote application logs of applications executing remotely, application administrators first must log into each remote system. Managing remote logins while arranging multiple display windows through which individual application logs of corresponding applications can be a tedious task. Moreover, managing the application information in each application log can become more complex as the number of concurrently executing applications increases beyond more than a few applications. In consequence, application administrators cannot easily open, view and compare the logs of the remote applications within a single work space.

### SUMMARY OF THE INVENTION

The present invention overcomes the limitations of conventional log viewers and provides a novel and non-obvious log management system through which both local and remote logs can be viewed and managed concurrently. In one aspect of the invention, a consolidated log manager can include concurrently displayable log windows, each log window displaying log text from different logs in a distributed system. The system further can include a log loader configured to locate the different logs in the distributed system and to load log text from the located different logs in the log windows.

In the consolidated log manager of the present invention, each log window can include a log text editor configured to edit log text loaded in the log window. Additionally, the distributed system can include at least one application server configured to serve application content from origin servers disposed about a computer communications network. Finally, the different logs can include logs remotely disposed from the consolidated log manager about a computer communications network, as well as logs which are local to the consolidated log manager.

A method for concurrently managing application component logs in a consolidated log manager can include the steps of selecting at least two application components; locating and retrieving component logs which correspond to the selected application components; providing a user interface through which the retrieved component logs can be viewed and managed; and, concurrently displaying the retrieved component logs in the user interface. Notably, the locating step can include the step of identifying the component logs in a network directory. Likewise, the retrieving step can include retrieving the component logs over the computer communications network.

The method of the invention further can include selecting one of the displayed component logs and copying the displayed component log to a new display window. Similarly, the method can include selecting one of the displayed component logs; activating an administrative console for displaying references to the application components; and, highlighting an application component which corresponds to the selected component logs. The method yet further can include assembling a list of all displayed component logs; presenting the list in a dialog box; and, activating the selected component logs present in the list. Finally, the method can further include prompting for at least one keyword; searching the displayed component logs for the keyword; and, if the keyword can be found in the displayed component logs, activating the displayed component log in which the keyword can be found and highlighting the keyword in the activated displayed component log.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic illustration of a distributed system in which the consolidated log manager of the present invention can be deployed;

FIG. 2 is a screen shot of a distributed application administration console for use in managing distributed application components and system services in the distributed system of FIG. 1;

FIG. 3 is a screen shot of an exemplary configuration of the consolidated log manager of FIG. 1;

FIG. 4 is a screen shot of exemplary log management features in the consolidated log manager of FIG. 3; and,

FIG. 5 is a screen shot of a dialog box for selectively managing particular ones of the application logs in the consolidated log manager of FIG. 3.

### DETAILED DESCRIPTION OF THE PREFERRED EMBODIMENTS

The present invention is a system and method for managing multiple remote and local logs within a consolidated log manager. In particular, in accordance with the present invention, application component logs can be viewed and managed concurrently within a consolidated log manager. Notably, the logs can be viewed and managed in the consolidated log manager, whether individual ones of the logs are remote or local to the consolidated log manager. In consequence, unlike the prior art single log display windows solution, in the present invention log management operations can be performed on all, some or individual ones of the logs.

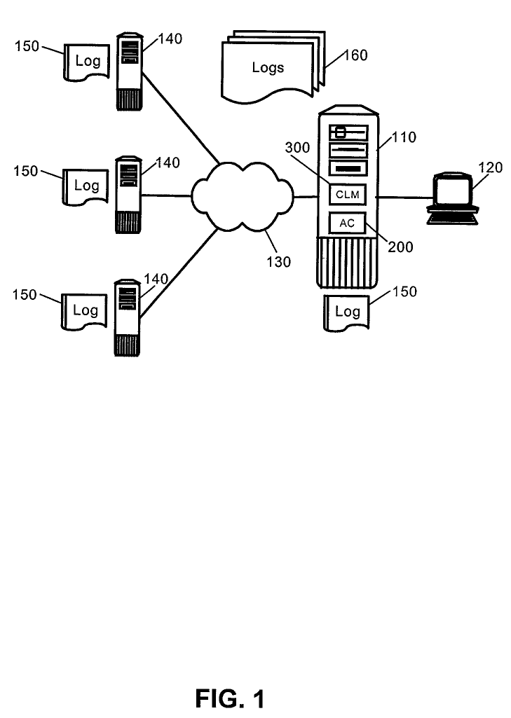

FIG. 1 is a schematic illustration of a distributed system in which the consolidated log manager of the present invention can be deployed. In accordance with the present invention, the consolidated log manager 300 can be deployed along with an administrative console 200 in an administrative server 110 within a distributed system. The distributed system itself can include one or more administrative servers 110 and one or more remote application servers 140, each communicatively linked over the computer communications network 130.

Notably, as one skilled in the art will recognize, the schematic illustration of FIG. 1 merely represents one exemplary configuration of a suitable distributed system. In fact, other configurations can be equally suitable including but not limited to configurations which include local application servers, and configurations where the administrative server is included with the application server in the same computing device. Moreover, multiple administrative servers can be provided both locally and remotely in which various administrative applications can be deployed, including but not limited to the administrative console 200 and the consolidated log manager 300.

Application components deployed in the application servers 140 can produce component logs 150 as is well known in the art. Additionally, where local application components are deployed in a local application server, such as the case where the local application server has been combined with the administrative server 110, local component logs can be produced, as well. Importantly, the logs 150 are not strictly limited to application component logs. Rather, the logs 150 also can be produced in the course of operating system services in the distributed system of FIG. 1.

In accordance with the present invention, a system administrator of the distributed system can access the administrative console 200 disposed in the administrative server 110 through a computing device 120, such as a desktop PC or workstation. The administrative console 200 can provide a user interface through which the system administrator can monitor and manage selected computing devices, application components and system services. Significantly, in one aspect of the present invention, a consolidated log manager 300 can be accessed through the administrative console 200.

The consolidated log manager 300 can provide a display window through which a selected set of logs 160 can be viewed and managed. The selected set of logs 160 can include individual ones of the application component and system services logs 150 distributed about the system of FIG. 1. Advantageously, the consolidated manager 300 can provide a user interface for managing the set of logs 160, regardless of the location of each individual log 150 in the set 160. In fact, from the perspective of the systems administrator, each log 150 in the set 160 can be presented concurrently within the consolidated log manager 300 regardless of which each log 150 is located remotely from or locally to the administrative server 110 hosting the consolidated log manager 300.

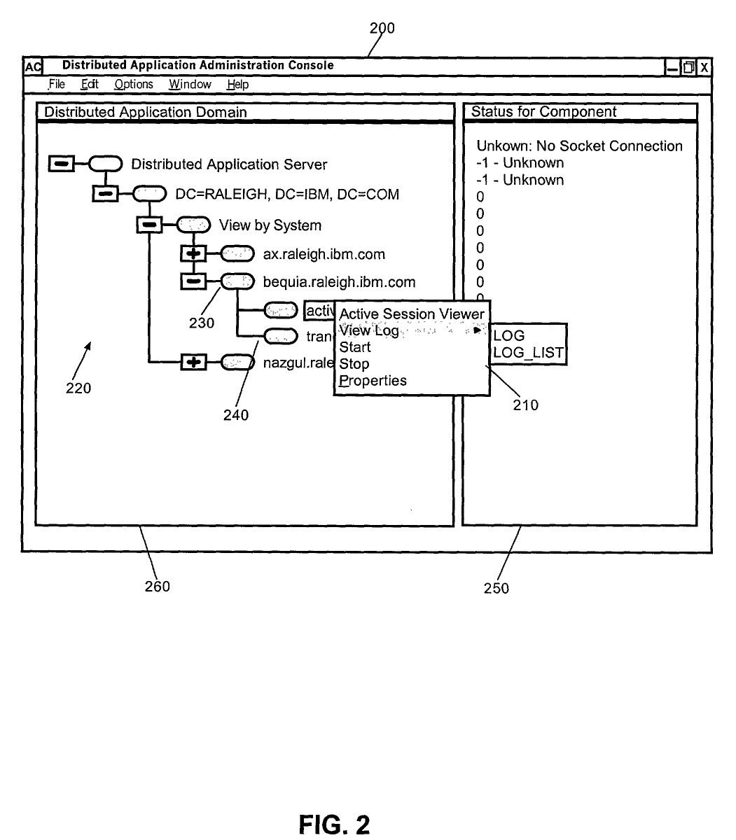

In operation, a systems administrator can access the consolidated log manager 300 directly or through another systems management component in the administrative server 110. For example, in a preferred aspect of the invention, the consolidated log manager 300 can be accessed through the administration console 200. FIG. 2 is a screen shot of the distributed application administration console 200 of FIG. 1. As will be apparent to one skilled in the art, a distributed application administration console can be used to manage distributed application components and system services in a distributed system.

For example, International Business Machines Corporation of Armonk, N.Y. has manufactured the WebSphere® Everyplace Server® suite of application deployment tools in which an administration console is provided through which individual computing devices, computing services and application components can be managed. As shown in FIG. 2, the administration console 200 can include a window 260 through which a graphical representation 220 of individual servers 230, and computing services and applications components 240 deployed in the distributed system can be provided. Optionally, a status window 250 can be provided through which the status of selected ones of the individual servers 230 and computing services and application components 240 can be displayed.

In any case, in accordance with the preferred aspect of the present invention, the consolidated log manager 300 of the present invention can be accessed through a drop down menu 210 within the administration console 200 by selecting a displayed server 230 or computing service or application component 240 and requesting to view the individual log associated with the selection. Alternatively, the systems administrator can select a “View All Logs” option. Notably, upon the systems administrator selecting the “View All Logs” option, the consolidated log manager 300 can locate and open the default log for each component installed in the system. By comparison, where the systems administrator selects to view only the logs of an individual server 230, computing service or application component 240, a list of all logs for the selection can be presented and one or more of the selections can be located and opened.

Some application components 240 can include multiple log files. For example, where a Web server has both an error log and an access log. Also, some application components 240 can maintain older log files. For instance, an application component 240 can cycle associated log files periodically, maintaining each log file for a fixed period of days. Reviewing older log files, of course, can be useful in isolating particular application problems. As multiple logs can be managed for a single application component 240, in the case of a multiple logs, the multiple logs can be accessed from drop down menu 210.

As will be recognized by one skilled in the art, mechanically, selected logs can be located and loaded in the consolidated log manager 300 in a manner which remains transparent to the systems administrator. Specifically, the identity and location of a selected log can be determined and subsequently, if the log is located remotely from the administrative server 110 hosting the consolidated log manager 300, the remote log can be retrieved over the computer communications network 130. Many methodologies can be applied to locate and download the selected logs, including directory look-up services and direct network requests to the server hosting the selected service or application component.

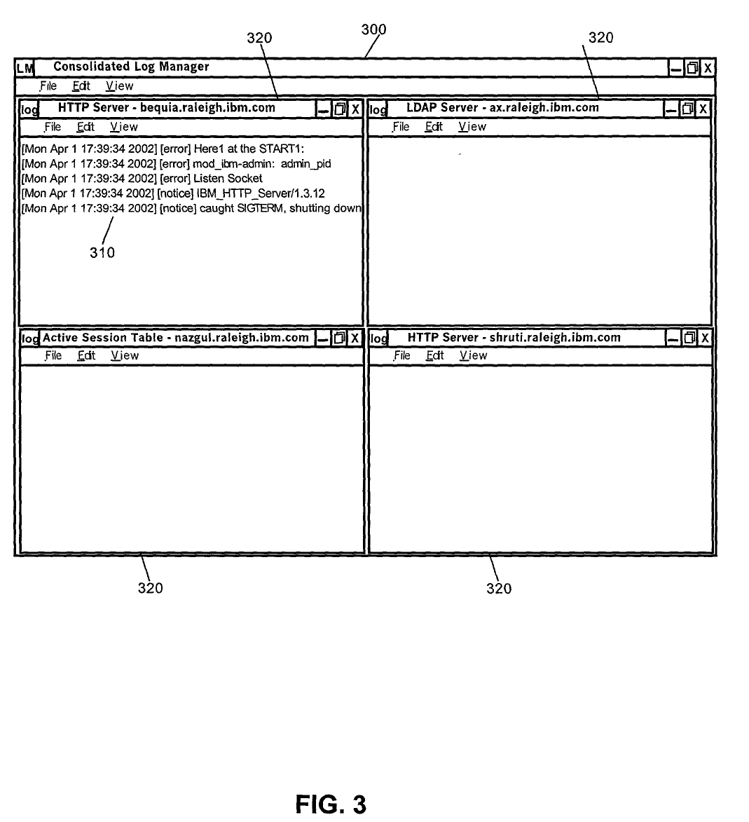

FIG. 3 is a screen shot of an exemplary configuration of the consolidated log manager 300 of FIG. 1. From FIG. 3, one skilled in the art will recognize the immediate advantage of the present invention in which the logs of differing application components can be displayed and managed concurrently within a single log manager, in this case the consolidated log manager 300. The consolidated log manager 300 can include multiple log windows 320 for each application component or system service selected by the systems administrator for log management. In accordance with well known file viewing and editing technologies, the text 310 within the logs not only can be displayed in the log windows 320, but also the text 310 can be displayed and managed in the same manner as text can be managed in any other document through a conventional text editor. In that regard, the log windows 320 can be tiled, cascaded or manually positioned. Likewise, conventional clipboard operations such as Cut/Copy/Paste can be provided.

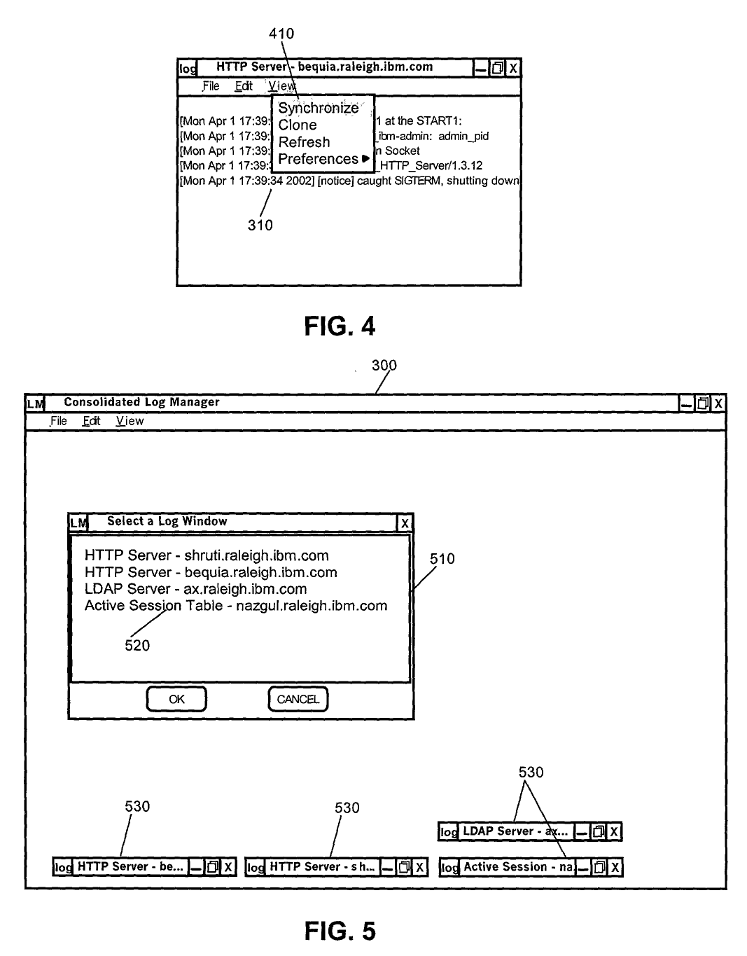

FIG. 4 is a screen shot of exemplary log management features for a log window 320 in the consolidated log manager 300 of FIG. 3. As shown in FIG. 3, the log window 320 can include a view menu 410. Exemplary view menu options can include “Clone”, “Synchronize” and “Refresh”. While the Clone option can cause the consolidated log manager 300 to copy the text 310 of the log to a new log window 320, the Synchronize option can link the systems administrator to the selected server 230, application component or systems service 240 within the administration console 200 which corresponds to the log in the log window 320. The Refresh option, by comparison, can update the view of the log in the log window 320.

FIG. 5 is a screen shot of a dialog box for selectively managing particular ones of the application logs in the consolidated log manager 300 of FIG. 3. Specifically, where multiple log windows 530 have been opened in the consolidated log manager 300, it can become difficult to locate and peruse the contents of any one log. In consequence, a log list dialog box 510 can be provided in which a log list 520 of log windows 530 can be provided. The systems administrator can use the log list 520 to select those log windows 530 which ought to be restored and/or activated. Additionally, a find option can be provided for locating by keyword either individual log windows 530, or text within the individual log windows 530.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A consolidated log manager comprising:
a plurality of concurrently displayable log windows, each log window displaying log text from different logs in a distributed system; and,
a log loader configured to locate said different logs in said distributed system and to load log text from said located different logs in said log windows.

2. The consolidated log manager of claim 1, wherein each said log window comprises a log text editor configured to edit log text loaded in said log window.

3. The consolidated log manager of claim 1, wherein said distributed system comprises at least one application server configured to serve application content from origin servers disposed about a computer communications network.

4. The consolidated log manager of claim 1, wherein said different logs comprise logs remotely disposed from the consolidated log manager about a computer communications network.

5. A method for concurrently managing application component logs in a consolidated log manager, the method comprising the steps of:
selecting at least two application components;
locating and retrieving component logs which correspond to said selected application components;
providing a user interface through which said retrieved component logs can be viewed and managed; and,
concurrently displaying said retrieved component logs in said user interface.

6. The method of claim 5, further comprising the steps of:
selecting one of said displayed component logs; and,
copying said displayed component log to a new display window.

7. The method of claim 5, further comprising the steps of:
selecting one of said displayed component logs;
activating an administrative console for displaying references to said application components; and,
highlighting an application component which corresponds to said selected one of said displayed component logs.

8. The method of claim 5, further comprising the steps of:
assembling a list of all displayed component logs;
presenting said list in a dialog box; and,
activating selected ones of said component logs present in said list.

9. The method of claim 5, further comprising the steps of:
prompting for at least one keyword;
searching said displayed component logs for said keyword; and,
if said keyword can be found in said displayed component logs, activating said displayed component log in which said keyword can be found and highlighting said keyword in said activated displayed component log.

10. The method of claim 5, wherein said locating step comprises the step of identifying said component logs in a network directory.

11. The method of claim 5, wherein said retrieving step comprises retrieving said component logs over a computer communications network.

12. A machine readable storage having stored thereon a computer program for Concurrently managing application component logs in a consolidated log manager, the computer program comprising a routine set of instructions for causing the machine to perform the steps of:
selecting at least two application components;
locating and retrieving component logs which correspond to said selected application components;
providing a user interface through which said retrieved component logs can be viewed and managed; and,
concurrently displaying said retrieved component logs in said user interface.

13. The machine readable storage of claim 12, further comprising the steps of:
selecting one of said displayed component logs; and,
copying said displayed component log to a new display window.

14. The machine readable storage of claim 12, further comprising the steps of:
selecting one of said displayed component logs;
activating an administrative console for displaying references to said application components; and,
highlighting an application component which corresponds to said selected one of said displayed component logs.

15. The machine readable storage of claim 12, further comprising the steps of:
assembling a list of all displayed component logs;
presenting said list in a dialog box; and,
activating selected ones of said component logs present in said list.

16. The machine readable storage of claim 12, further comprising the steps of:
prompting for at least one keyword;
searching said displayed component logs for said keyword; and,
if said keyword can be found in said displayed component logs, activating said displayed component log in which said keyword can be found and highlighting said keyword in said activated displayed component log.

17. The machine readable storage of claim 12, wherein said locating step comprises the step of identifying said component logs in a network directory.

18. The machine readable storage of claim 12, wherein said retrieving step comprises retrieving said component logs over a computer communications network.
